(19) United States
(12) Patent Application Publication
(10) Pub. No.: US 2009/0098434 A1
(43) Pub. Date: Apr. 16, 2009

(54) FUEL CELL AND METHOD FOR PRODUCING THE SAME

(76) Inventors: Seiji Sano, Shizuoka-ken (JP); Takashi Kajiwara, Shizuoka-ken (JP); Hiromichi Sato, Kanagawa-ken (JP); Yutaka Hotta, Shizuoka-ken (JP); Yoshifumi Ota, Shizuoka-ken (JP); Fumishige Shizuku, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/293,018

(22) PCT Filed: Mar. 15, 2007
(86) PCT No.: PCT/IB07/00646

§ 371 Date: Sep. 15, 2008

(30) Foreign Application Priority Data
Mar. 16, 2006 (JP) 2006-072163

(51) Int. Cl. H01M 8/10; B29C 65/00

(52) U.S. Cl. 429/30; 156/293

(57) ABSTRACT

A fuel cell including a separator (40), a porous body (27) through which reaction gas flows, and a power generating unit (20) having a built-in seal gasket, in which the porous body (27) has a prevention section (50) formed on its outer perimeter, the porosity of the prevention section (50) being lower than the porosity of the porous body (27).

### BACKGROUND OF THE INVENTION

1. Field of the Invention

The present invention relates to a fuel cell for generating electricity by supplying reaction gas and to a method for producing the fuel cell. More particularly, the invention relates to a porous body in the fuel cell, to which reaction gas is supplied.

2. Description of the Related Art

Fuel cells employ a basic stacked structure in which a power generating unit, which includes an electrolyte membrane and an electrode catalyst layer, and a separator as a partition are stacked alternatively. For such components used in the fuel cell, several types of structures are under consideration.

For example, one fuel cell, disclosed in JP-A-2004-6104, uses a separator made up of three stacked plates. Another fuel cell disclosed in JP-A-2005-93243 employs a structure in which a gas diffusion layer has high hydrophilic parts on its periphery.

Alternatively, a porous body of a certain porosity can be used to flow reaction gas to be utilized for generating electricity in the fuel cell. In these fuel cells, a gasket with a seal line for preventing leakage of reaction gas is provided on the outer perimeter of the power generating unit. Also, porous bodies are disposed on the both sides of the power generating unit, and separators are disposed on the outer sides of the respective porous bodies.

The above structure of fuel cells creates a cavity (gap) between the outer perimeter of each porous body and the seal line (lip). Reaction gas, supplied to the porous bodies of the fuel cell, flows out undesirably into the cavity where the flow channel resistance is low, resulting in the reduced reaction gas utilization rate.

### SUMMARY OF THE INVENTION

An object of the invention is to provide a fuel cell which prevents leakage of reaction gas into the cavity (gap) and a method for producing the fuel cell.

One aspect of the invention is directed to a fuel cell for generating electricity by supplying a reaction gas, the fuel cell having: a power generating unit including an electrolyte membrane and an electrode; a separator which serves as a partition and collects electric current generated by the power generating unit, the separator being disposed on each side of the power generating unit; a seal gasket which is disposed on an outer perimeter of the power generating unit and substantially contacts the separator to establish a seal line for preventing leakage of the reaction gas; a porous body which is interposed between the power generating unit and the separator and has a certain porosity, the porous body being supplied with the reaction gas through the separator; and a prevention section for preventing the reaction gas supplied to the porous body from flowing out into a cavity surrounded by the separator, the seal line and the porous body.

In accordance with the aspect of the invention, the function of the prevention section can prevent the reaction gas from flowing out into the cavity surrounded by the separator, the seal line and the porous body. This allows the reaction gas to properly flow through the interior of the porous body. Consequently, the amount of unused reaction gas in the fuel cell is reduced, thereby minimizing a drop in the reaction gas utilization rate.

The prevention section of the fuel cell thus configured may be provided on the porous body and have a porosity lower than the porosity of the porous body.

In such fuel cell, the prevention section is provided on the porous body and has the lower porosity compared to the porous body itself. More specifically, the reaction gas flows less easily through the prevention section whose porosity is lower and accordingly flow resistance is higher. Therefore, the function of the prevention section allows the reaction gas to properly flow through the interior of the porous body.

The porous body of the fuel cell thus configured may be formed into a rectangle having a certain thickness. The prevention section may be located along two sides of the rectangle, the two sides extending approximately parallel to a flow direction of the reaction gas supplied to the porous body.

In such fuel cell, the prevention section is provided on the two sides extending approximately parallel to the direction of the reaction gas flow through the porous body. This can reduce the amount of the reaction gas leaked into the cavity in the process of flowing through the interior of the porous body. Consequently, this minimizes a drop in the reaction gas utilization rate. Further, the prevention section thus provided is easier to produce, compared to the case that a prevention section is provided along an entire side edge of the porous body.

The prevention section of the fuel cell thus configured may be located along the entire side edge of the porous body. The separator may have holes for the reaction gas supply to and discharge from the porous body at locations on the inner side of the prevention section, the holes facing the porous body itself.

In such fuel cell, the porous body has the prevention section on the entire side edge thereof. Therefore, the amount of the reaction gas leaked into the cavity can be reduced. Deviating from the prevention section, the holes of the separator are located to face the porous body itself. This ensures a proper supply of the reaction gas into the fuel cell.

The prevention section of the fuel cell thus configured may be a resin member having a shape to fill the cavity.

In such fuel cell, the resin member is disposed to fill the cavity surrounded by the separator, the seal line and the porous body. This minimizes leakage of the reaction gas into the cavity, thereby allowing the reaction gas to flow property through the interior of the porous body. Consequently, the amount of unused reaction gas in the fuel cell is reduced, thereby minimizing a drop in the reaction gas utilization rate.

The prevention section, embodied as a lower porosity section of the porous body, may be formed by compressing a part of the porous body in a stacking direction in the power generating unit. While a recessed portion is formed on the compressed part of the porous body, the separator is provided with a protruding portion at a location corresponding to the recessed portion, so that the separator is fitted into the recessed portion. This prevents leakage of the reaction gas, concurrently with positioning the separator, which is convenient.

Another aspect of the invention is directed to a method for producing a fuel cell that generates electricity from a supply of reaction gas, the method including: providing a power generating unit including an electrolyte membrane and an electrode, a separator that serves as a partition and collects electric current-generated by the power generating unit, the separator being disposed on each side of the power generating unit, and a porous body having a certain porosity to serve as a flow channel for flowing the reaction gas in a given direction; disposing a seal gasket on an outer perimeter of the power generating unit, the seal gasket substantially contacting the separator to establish a seal line for preventing leakage of the reaction gas; forming a lower porosity section on a part of the porous body, whose porosity is lower than the porosity of the porous body, in order to prevent the reaction gas supplied to the porous body from flowing out into the cavity surrounded the separator, the seal line and the porous body; and stacking the separator and the power generating unit alternately, with the porous body being interposed between the separator and the power generating unit.

In accordance with the production method according to the another aspect of the invention, the porous body partly has the lower porosity section, and this porous body, serving as a flow channel, is integrally formed into the fuel cell. The lower porosity section thus provided prevents the reaction gas from flowing out into the cavity surrounded by the separator, the seal line and the porous body. Hence, the production of the fuel cell, which can minimize a drop in the reaction gas utilization rate, is achieved. The lower porosity section formed as a part of the porous body may be replaced with a resin member disposed to fill the cavity.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 illustrates a general configuration of a fuel cell according to a first embodiment of the invention.

FIG. 2 is a sectional view of a part of the fuel cell according to the first embodiment, which is cut along the stacking direction.

FIG. 3 is a plane view illustrating a part of the fuel cell viewed from the stacked plane.

FIGS. 4A and 4B illustrate an example of porous bodies respectively having prevention sections along the two sides.

FIG. 5 illustrates a general configuration of a part of a fuel cell according to a second embodiment of the invention.

FIG. 6 is a sectional view of a part of the fuel cell according to the second embodiment, which is cut along the stacking direction.

FIG. 7 illustrates one example of the formation process of a prevention section having a low porosity.

FIG. 8 illustrates another example of the formation process of a prevention section having a low porosity.

### DETAILED DESCRIPTION OF THE PREFERRED EMBODIMENTS

Description is hereinafter made of the present invention based on the embodiments thereof in the following order.

### A. First Embodiment

### A-1. General Configuration of Fuel Cell

### A-2. Porous Body Structure

### B. Second Embodiment

### B-1. General Configuration of Fuel Cell

### C. Modifications

### A. First Embodiment

A-1. General Configuration of Fuel Cell:

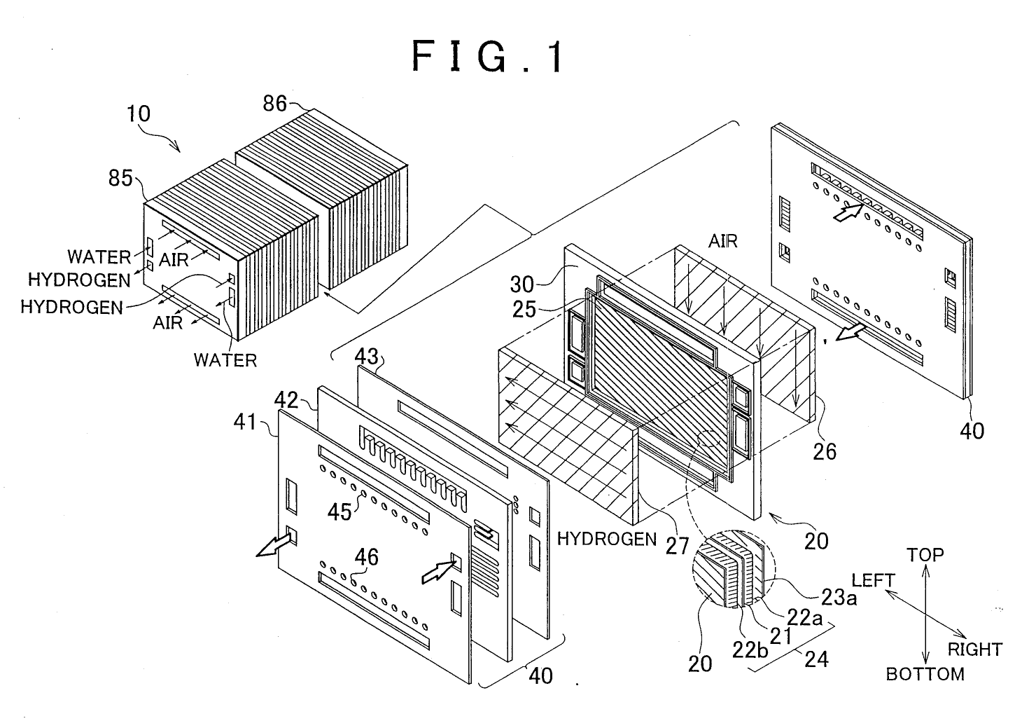

FIG. 1 illustrates a general configuration of a fuel cell according to a first embodiment of the invention. A fuel cell 10 is a polymer electrolyte fuel cell designed to be supplied with hydrogen gas and air to generate electricity through an electrochemical reaction between hydrogen and oxygen. The fuel cell 10 is mounted in a vehicle and used as a power source.

As shown in FIG. 1, the fuel cell 10 includes, as main components, a power generating unit 20 having an electrolyte membrane 21; porous bodies 26 and 27 through which hydrogen gas and air (herein after referred to as reaction gas) flows; and separators 40 as a partition for collecting the electricity generated by an electrochemical reaction. One of the separators 40, the porous body 27, the power generating unit 20, the porous body 26, and the other separator 40 are stacked in the described order in a repeated manner. These stacked components are interposed between end plates 85 and 86, thus forming a unit of the fuel cell 10.

The end plate 85 has through holes for supplying or discharging reaction gas. The reaction gas is supplied constantly from an external hydrogen tank and compressor (both are not shown) to the interior of the fuel cell 10 via the through holes.

The power generating unit 20 is a single unit constituted by a component 25 and a seal gasket 30 that surrounds the outer perimeter of the component 25. The component 25 has a membrane electrode assembly (MEA) 24 including a polymer electrolyte membrane 21, and gas diffusion layers 23a and 23b provided on the outsides of the MEA 24. The component 25 having the MEA 24 and the gas diffusion layers 23a and 23b is hereinafter referred to as MEGA 25.

The MEA 24, a part of the MEGA 25, has electrode catalyst layers 22a and 22b (cathode and anode) on the respective surfaces of the electrolyte membrane 21. The electrolyte membrane 21, having proton conductivity, is a thin membrane made of a polymer material exhibiting excellent electrical conductivity in wet conditions. The electrolyte membrane 21 is formed into a rectangular profile smaller than the profile of the separator 40. The electrode catalyst layers 22a and 22b, formed on the respective surfaces of the electrolyte membrane 21, contain a catalyst, such as platinum, for promoting an electrochemical reaction.

The gas diffusion layers 23a and 23b, provided on the outsides of the MEA 24, are porous bodies having an approximately 60-70% porosity and are made of carbon, for example, carbon cloth and carbon paper. The gas diffusion layers 23a and 23b of such carbon material are bonded with the MEA 24, forming the MEGA 25 as a single piece. The gas diffusion layer 23a is located on the cathode side of the MEA 24, while the gas diffusion layer 23b is located on the anode side. These gas diffusion layers 23a and 23b diffuse reaction gas in the thickness direction thereof to supply the reaction gas across the entire planes of the corresponding electrode catalyst layers 22a and 22b.

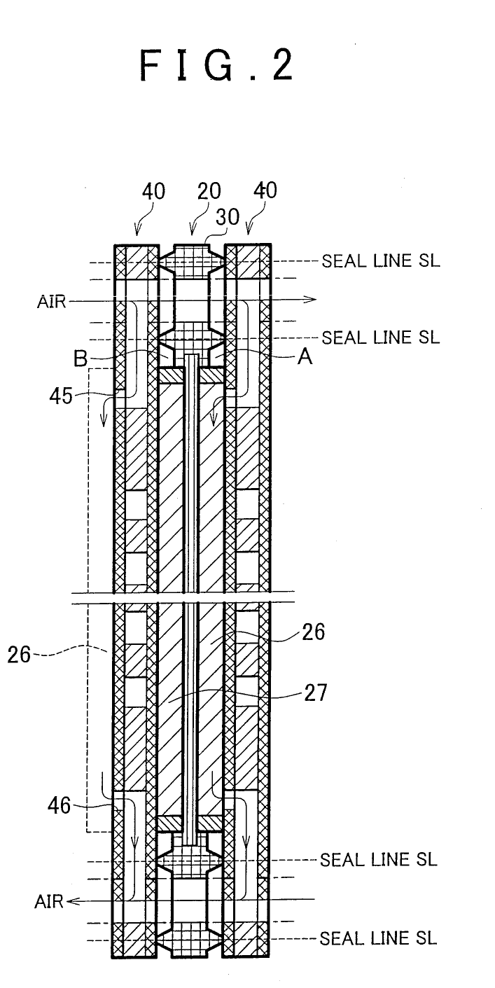

The seal gasket 30 surrounding the outer perimeter of the MEGA 25 is made of an elastic resin insulating material, such as silicon rubber, butyl rubber and fluoro-rubber. The seal gasket 30 is formed by injection molding on the outer perimeter of the MEGA 25 such that the gasket 30 has an area in which a part of the outer perimeter of the MEGA 25 is interposed in the thickness direction (see FIG. 2).

The seal gasket 30 is formed into an approximately rectangular profile, which is the approximately identical with the profile of the separator 40. Through holes that function as reaction gas manifolds and a coolant manifold are provided along the four sides of the seal gasket 30. Because the through holes for the manifolds are the same in structure as those provided for the separator 40, the details of these through holes will be discussed later in addition to the structure of the separator 40.

The seal gasket 30 includes sections protruding in its thickness direction so as to surround the respective through holes for the manifolds. The protruding sections substantially contact the opposed separators 40 that sandwich the seal gasket 30. The protruding sections are tightened and deformed under the given stacking load. Consequently, the protruding sections establish a seal line SL for preventing leakage of fluids (hydrogen, air, coolant) running through the respective manifolds. Each protruding section is equivalent to a lip through which the seal line SL extends (see FIG. 2).

The fuel cell 10 according to the first embodiment is designed to prevent leakage of the fluids from the interior of the fuel cell 10 by means of sandwiching the seal gasket 30 between the separators, but not by means of bonding a resin flame or other member between the separators. This reduces the number of parts required for the fuel cell 10, such as resin flame, resulting in the reduced volume and weight of the cell.

Description will now be made of the porous bodies 26 and 27 through which reaction gas flows. The porous bodies 26 and 27 are made of metal having plurality of fine pores therein, such as foam metal and metal mesh of stainless steel, titanium or titanium alloy. Each of the porous bodies 26 and 27 is formed into an approximately rectangular profile smaller than the profile of the MEGA 25, so that the porous bodies can fall within the seal gasket 30.

The porous bodies 26 and 27 have an approximately 70-80% porosity which is higher than the porosity of the gas diffusion layers 23a and 23b forming a part of the MEGA 25. The porous bodies 26 and 27 serve as a flow channel for supplying reaction gas to the MEGA 25.

For example, the porous body 26 is disposed between the MEGA 25 (cathode of the MEA 24) and the separator 40 on the cathode side to allow air supplied through the separator 40 to flow from the top to bottom as shown in the figures and toward the cathode side of the MEGA 25.

In turn, the porous body 27 is disposed between the MEGA 25 (anode of the MEA 24) and the separator 40 on the anode side to allow hydrogen gas supplied through the separator 40 to flow from the right to left as shown in the figures and toward the anode side of the MEGA 25.

More specifically, because the porous bodies 26 and 27 are predominantly intended to flow reaction gas in a given direction, the porosity thereof is set higher enough to minimize pressure loss of the reaction gas flow and improve the drainage performance. In contrast, because the aforementioned gas diffusion layers 23a and 23b are predominantly intended to diffuse gas in the thickness direction, the porosity thereof is set lower relative to the porous bodies 26 and 27.

Reaction gas is supplied to the MEGA 25 in the process of flowing through the porous bodies 26 and 27. The reaction gas is then diffused into the respective electrode catalyst layers 22a and 22b due to the function of the gas diffusion layers 23a and 23b of the MEGA 25. Thus, the reaction gas is provided for a reaction. This electrochemical reaction is an exothermic reaction, and the fuel cell 10 is operated in a predetermined temperature range. Coolant is therefore supplied into the fuel cell 10.

The separator 40 for collecting electricity generated by the electrochemical reaction will now be described. The separator 40 is a three-layered separator with three metal thin plates stacked. To be more specific, the separator 40 includes a cathode plate 41, an anode plate 43 and an intermediate plate 42. The cathode plate 41 contacts the porous body 26 for air flow. The anode plate 43 contacts the porous body 27 for hydrogen gas flow. The intermediate plate 42, interposed between the cathode and anode plates, serves as a flow channel mainly for coolant.

The separator 40 is made of a conductive metal material, such as stainless steel, titanium and titanium alloy. The separator 40 has a flat surface with no recesses or protrusions intended for flow channels in the thickness direction (i.e. the flat contact surface between the separator and the porous body 26 or 27).

The three plates have through holes establishing the respective manifolds. More specifically, as shown in FIG. 1, the separator 40, shaped into an approximately rectangle, has through holes for air supply and discharge respectively on its upper and lower longer sides. In addition, as shown in FIG. 1, the separator 40 has through holes for hydrogen supply and discharge respectively at the upper part of its right shorter side and the lower part of its left shorter side. Further, as shown in FIG. 1, the separator 40 has through holes for coolant supply and discharge respectively at the upper part of its left shorter side and the lower part of its right shorter side.

In addition to these through holes for the manifolds, the cathode plate 41 has plural holes 45 and 46 as an air inlet to and outlet from the porous body 26. Similarly, in addition to those through holes for the manifolds, the anode plate 43 also has plural holes (not shown) as a hydrogen gas inlet to and outlet from the porous body 27.

The intermediate plate 42 has plural through holes for the manifolds. Some through holes are designed for the air manifold to communicate with the holes 45 and 46 of the cathode plate 41. Some through holes are designed for the hydrogen gas manifold to communicate with the holes of the anode plate 43.

The intermediate plate 42 has plural notches formed in the direction of the longer side of the approximately rectangular profile. The both ends of each notch communicate with the through holes for the coolant manifold.

The three plates thus constructed are stacked and joined together, defining flow channels specific for the type of fluids in the separator 40.

FIG. 2 is a sectional view of a part of the fuel cell 10 according to the first embodiment, which is cut along the stacking direction. As shown in FIG. 2, part of the air flowing in the manifold defined by the stacked separator 40 and seal gasket 30 passes through the interior (the intermediate plate 42) of the separator 40 and the holes 45 to be supplied to the porous body 26. The gas resulting from the reaction and the unused air for the reaction flow through the porous body 26, the holes 46, the interior of the separator 40 and then to the manifolds. Since hydrogen gas flows in the same manner as air, the flow process will not be described repeatedly.

As shown in FIG. 2, in the fuel cell 10 including the aforementioned components according to the first embodiment, a cavity A (or a cavity B) is defined by the separator 40, the seal line SL (gasket 30) and the porous body 26 (or the porous body 27). In other words, gaps are created between the respective lips on the seal line SL, and the outer surfaces of the porous bodies 26 and 27. Thus, the reaction gas, supplied to the porous bodies 26 and 27 through the separators 40, tends to flow to the cavities A and B (also referred to as gaps) where there is little pressure loss, rather than flowing through the interior of the porous bodies having a certain porosity. As described in the first embodiment, the porous bodies 26 and 27 employ a structure to prevent leakage of the reaction gas into such cavities.

A-2. Porous Body Structure:

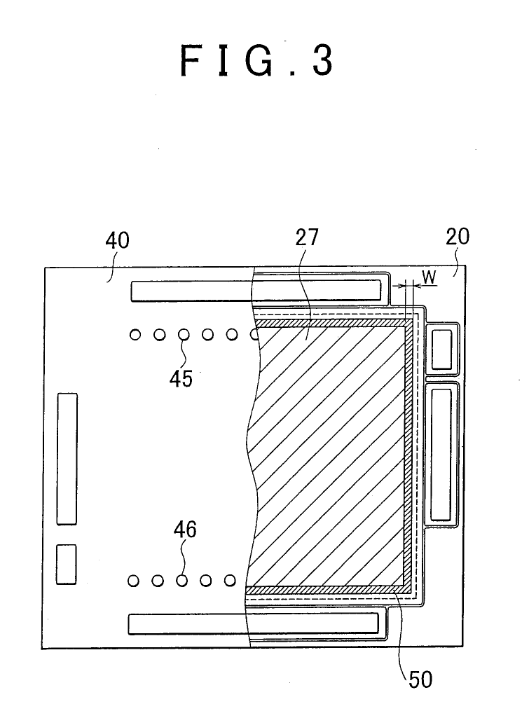

FIG. 3 is a plane view illustrating a part of the fuel cell 10 viewed from the stacked plane. As shown in FIG. 3, the power generating unit 20 (more specifically, the MEGA 25), the porous body 27 and the separator 40 are stacked from below in the described order.

The porous body 27, generally shaped into a rectangular profile, has a prevention section 50 of a certain width W along the entire outer perimeter. The prevention section 50 is designed to prevent leakage of the reaction gas into the aforementioned cavities (gaps) and have a porosity lower than the porosity of the porous body 27.

To be more specific, the porosity of the prevention section is adjusted in the sintering process of the porous body 27 using powder metal, such as stainless steel, titanium and titanium alloy, by means of increasing the amount of the powder metal used for an area in the mold, which corresponds to the prevention section of a certain width W. Thus, while the prevention section 50, that is, a part of the porous body 27, is made of the same material as for the porous body 27, the prevention section 50 has a porosity lower than the porosity of the porous body 27. Also, the porous body 26 has the prevention section 50 of a certain width W, although not shown in the figures.

The fuel cell 10 is provided with the built-in porous bodies 26 and 27 each having the thus-formed prevention section 50. In such fuel cell 10, reaction gas, supplied from the air holes 45 and hydrogen holes (not shown) of the separator 40 to each porous body 26 or 27, flows through the interior of the porous body 26 or 27 whose porosity is higher and pressure loss is lower, rather than flowing through the prevention section 50 whose porosity is lower. More specifically, the reaction gas supplied to the porous bodies 26 and 27 cannot flow out into the cavities A and B, where there is little pressure loss, without passing through the prevention sections 50 having a low porosity. Therefore, the prevention sections minimize leakage of the reaction gas into the cavities A and B.

As described above, the fuel cell 10 according to the first embodiment can minimize leakage of the reaction gas into the cavity A (or cavity B) defined by the separator 40, the seal line SL (the gasket 30) and the porous body 26 (or the porous body 27). In other words, the fuel cell 10 allows the reaction gas to flow through the interior of the porous body, instead of flowing into the gap around the outer perimeter of the porous body. This results in a reduction in the amount of unused reaction gas in the fuel cell 10, thereby minimizing a drop in the reaction gas utilization rate.

Although the porous bodies 26 and 27 are predominantly intended for allowing reaction gas to flow, a part of each porous body 26 or 27 has a porosity as low as the porosity of the gas diffusion layers 23a and 23b. This allows controlling the reaction gas flow, producing a more significant effect of preventing leakage of the reaction gas into the gaps.

Further, the prevention section 50 is formed integrally with each porous body 26 or 27 into a single piece, which avoids increases in the number of steps for assembling the fuel cell 10 as well as in the number of parts.

A certain width W of the prevention section 50 is determined depending on the profile of each porous body 26 or 27 and the arrangement of the holes 45 and 46 of the separator 40. More specifically, a certain width W is determined such that the reaction gas flowing through the holes 45 of the separator 40 is supplied not to the prevention section 50, but to the porous body 26 or 27. In other words, the holes 45 of the separator 40 are located on the inner side of the prevention section 50 to face the porous body 26 or 27 itself.

Determining a certain width W of the prevention section 50 and the location of the holes 45 of the separator 40 in the above manner allows the reaction gas to be smoothly supplied, even when each porous body 26 or 27 has the prevention section 50 formed across its entire side edge.

According to the description in the first embodiment of the invention, the porous body 26 or 27 has the prevention section 50 formed across its entire side edge. However, the prevention section 50 is not necessarily formed across the entire side edge of the porous body.

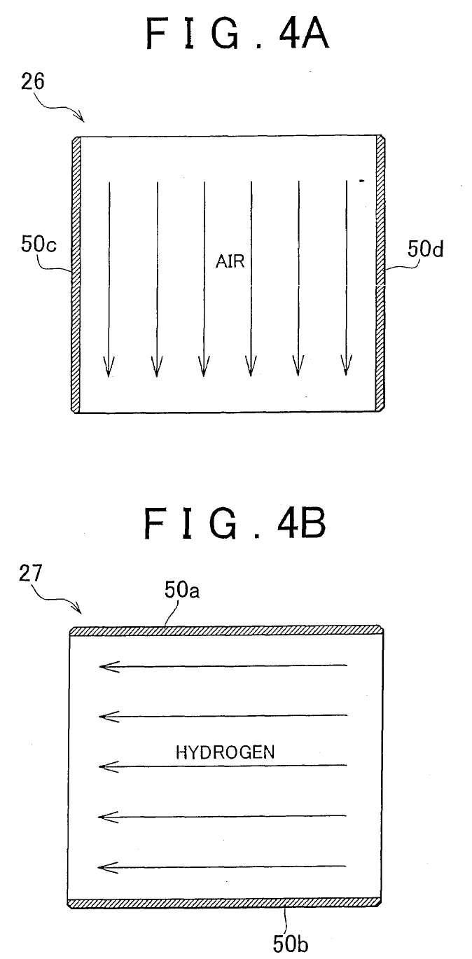

FIGS. 4A and 4B illustrate an example of porous bodies 26 and 27 respectively having prevention portions along the two sides. FIG. 4A shows the porous body 26 for air flow, while FIG. 4B shows the porous body 27 for hydrogen flow. As shown in FIG. 4A, the porous body 26 for air flow has prevention sections 50c and 50d on its shorter sides in a parallel positional relationship with air flow. In turn, as shown in FIG. 4B, the porous body 27 for hydrogen flow has prevention sections 50a and 50b on its longer sides in a parallel positional relationship with hydrogen flow.

The reaction gas, supplied in the vicinity of the outer perimeter of each porous body 26 or 27, tends to flow toward the gaps, where flow resistance is low, in the process of flowing through the interior of the porous body 26 or 27 in a given direction. As shown in FIGS. 4A and 4B, each porous body 26 or 27 is provided with the prevention sections on its two sides extending approximately parallel to the associated reaction gas flow within the porous body. This can minimize a drop in the reaction gas utilization rate. In addition, these prevention sections thus provided are easier to produce, compared to the case where a prevention section is provided along the entire side edge.

### B. Second Embodiment

B-1. General Configuration of Fuel Cell:

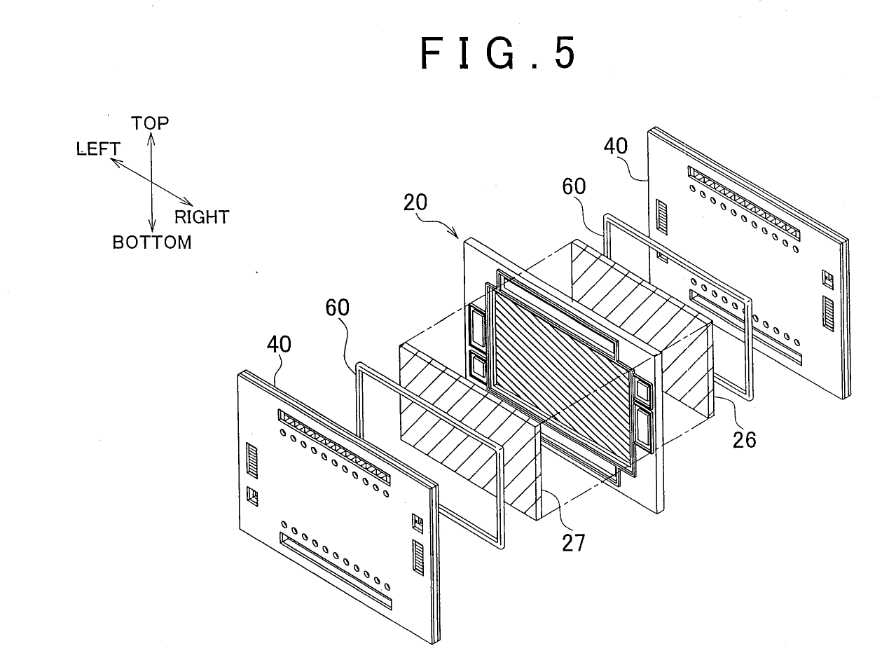

FIG. 5 illustrates a general configuration of a part of a fuel cell according to a second embodiment of the invention. The fuel cell in the second embodiment employs a basic structure that is the same as for the fuel cell 10 in the first embodiment. Therefore, components of the fuel cell 10 that are common to those in the first embodiment are denoted by the same reference numerals, and their description is not repeated.

As shown in FIG. 5, a unit of the fuel cell according to the second embodiment includes: the power generating unit 20; the seal gasket built in the power generating unit 20; the porous bodies 26 and 27, through which reaction gas flows, provided on the opposite sides of the power generating unit 20; and the separators 40 for sandwiching the porous bodies 26 and 27 from the outsides thereof. This unit structure is the same as in the first embodiment.

The fuel cell in the second embodiment has prevention sections 60 as a separate member from the porous bodies 26 and 27, in place of the prevention sections 50 formed as a part of each porous body 26 or 27 on the outer perimeter thereof in the first embodiment.

The prevention section 60 is made of an elastic resin insulating material, such as silicon rubber, butyl rubber and fluoro-rubber. The prevention section 60 is shaped into a flame to surround the outer perimeter of the approximately rectangular porous body 26 or 27.

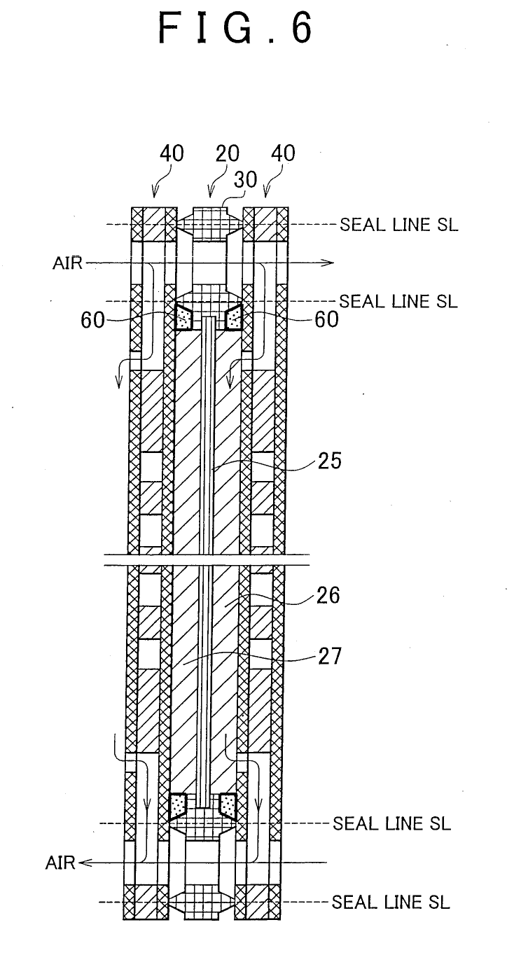

FIG. 6 is a sectional view of a part of the fuel cell according to the second embodiment, which is cut along the stacking direction. As shown in FIG. 6, the flame-shaped prevention section 60 is disposed so as to fill a cavity defined by the separator 40, the seal line SL (the gasket 30) and the porous body 26 (or the porous body 27).

According to the second embodiment, the fuel cell has the prevention section 60 thus shaped, thereby preventing the reaction gas supplied through the separator 40 to each porous body 26 or 27 from leaking into the cavity. Consequently, this minimizes a drop in the reaction gas utilization rate.

Further, the prevention section 60, which is formed as a separate component, can be easily built in the existing fuel cells.

It should be understood that, although the prevention section 60 may be made of a material that is the same as for the seal gasket 30, it would be more desirable to use a material softer than the material used for the seal gasket 30. The use of a softer material for the prevention section 60 compared to the seal gasket 30 causes the prevention section 60 to be easily deformed under the stacking load and to fill the cavity, while exerting less influence on the establishment of the seal line SL.

The prevention section 60 of resin is shaped into a flame in the second embodiment. Alternatively, the prevention section 60 may be designed to be integral with each porous body on its two sides parallel to the reaction gas flow associated with the respective porous bodies 26 and 27, as described in the first embodiment. This also minimizes a drop in the reaction gas utilization rate.

### C. Modifications

The several embodiments of the present invention have been discussed above. However, the invention is not limited to those embodiments, but may adopt various modifications without departing from the spirit and scope of the invention.

In the first embodiment, an amount of powder metal is increased in the sintering process of the porous body in order to form the prevention section 50 of a low porosity. Alternatively, after the formation of the porous body of a predetermined porosity (approximately 70-80%), a prevention section may be formed with an external force to ensure a lower porosity than the predetermined porosity.

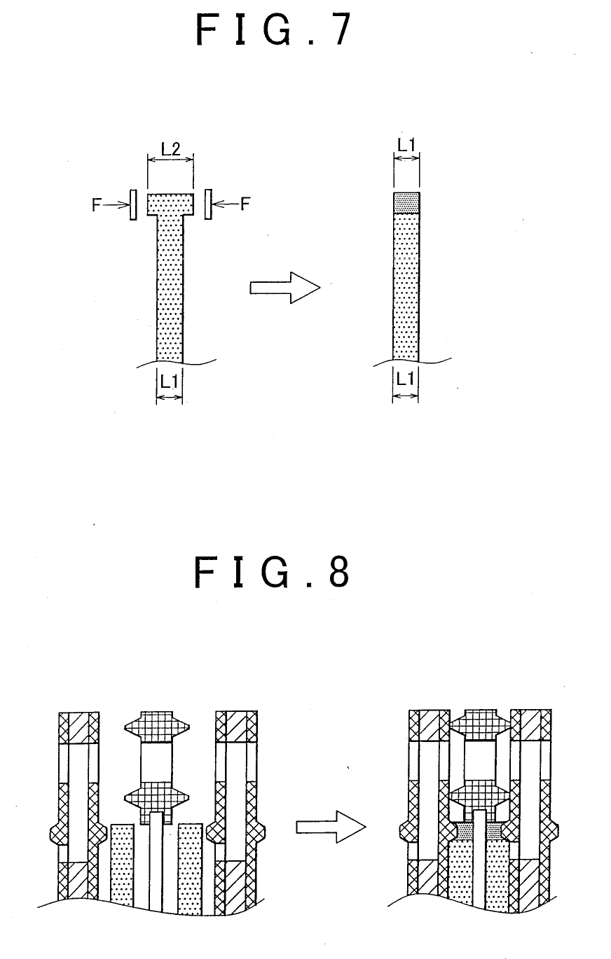

For example, as FIG. 7 shows an example of the formation process of the prevention section, the porous body of a thickness L1 have an additional portion of a thickness L2 to ensure a lower porosity. This portion of the thickness L2 is pressed by an external force F and deformed to the thickness L1. Thereby, a part of the prevention section can ensure a lower porosity.

As shown in FIG. 8, the separator may be designed to have a protruding section in its thickness direction at a location to meet where the prevention section is formed, and the separator may be subjected to a certain external tightening force. The tightening force causes the protruding section of the separator to press and deform a part of the porous body, which ensures a lower porosity. Alternatively, the prevention section may be provided by compressing a part of the porous body in advance, forming the compressed part into a recess, and fitting the protruding section of the separator into the recess. This facilitates positioning of the separator and the porous body.

1. A fuel cell for generating electricity by supplying a reaction gas comprising:
a power generating unit including an electrolyte membrane and an electrode;
a separator that serves as a partition and collects electric current generated by the power generating unit, the separator being disposed on each side of the power generating unit;
a seal gasket which is disposed on an outer perimeter of the power generating unit and substantially contacts the separator to establish a seal line for preventing leakage of the reaction gas;
a porous body which is interposed between the power generating unit and the separator and has a certain porosity, the porous body being supplied with the reaction gas; and
a prevention section for preventing the reaction gas supplied to the porous body from flowing out into a cavity surrounded by the separator, the seal line and the porous body.

2. The fuel cell according to claim 1, wherein
the prevention section is provided on the porous body and has a porosity lower than the porosity of the porous body.

3. The fuel cell according to claim 1 or 2, wherein
the porous body is formed into a rectangle having a certain thickness, and
the prevention section is located along two sides of the rectangle, the two sides extending approximately parallel to a flow direction of the reaction gas supplied to the porous body.

4. The fuel cell according to claim 1 or 2, wherein
the prevention section is located along an entire side edge of the porous body, and
the separator has holes for the reaction gas supply to and discharge from the porous body at locations on the inner side of the prevention section, the holes facing the porous body itself.

5. The fuel cell according to claim 1, wherein
the prevention section is a resin member having a shape to fill the cavity.

6. The fuel cell according to claim 2, wherein
the prevention section is formed by compressing a part of the porous body in a stacking direction of the power generating unit.

7. The fuel cell according to claim 6, wherein
the separator is provided with a protruding section at a location corresponding to a recess, the recess being formed on the compressed part of the porous body, so that the separator is fitted into the recess.

8. The fuel cell according to claim 2, wherein
the porous body is made of metal having fine pores therein, and
the prevention section is formed in a sintering process of the porous body, using an increased amount of powder metal for a part of the porous body.

9. A method for producing a fuel cell that generates electricity by supplying a reaction gas comprising:
providing for a power generating unit including an electrolyte membrane and an electrode, a separator that serves as a partition and collects electric current generated by the power generating unit, the separator being disposed on each side of the power generating unit, and a porous body having a certain porosity to serve as a flow channel for flowing the reaction gas in a given direction;
disposing a seal gasket on an outer perimeter of the power generating unit, the seal gasket substantially contacting the separator to establish a seal line for preventing leakage of the reaction gas;
forming a lower porosity section on a part of the porous body, the porosity being lower than the certain porosity, in order to prevent the reaction gas supplied to the porous body from flowing out into the cavity surrounded the separator, the seal line and the porous body; and
stacking the separator and the power generating unit alternately, with the porous body being interposed between the separator and the power generating unit.

10. A method for producing a fuel cell that generates electricity from a supply of reaction gas comprising:
providing for a power generating unit including an electrolyte membrane and an electrode, a separator that serves as a partition and collects electric current generated by the power generating unit, the separator being disposed on each side of the power generating unit, and a porous body having a certain porosity to serve as a flow channel for flowing the reaction gas in a given direction;
disposing a seal gasket on an outer perimeter of the power generating unit, the seal gasket substantially contacting the separator to establish a seal line for preventing leakage of the reaction gas;
placing a resin member to fill the cavity surrounded the separator, the seal line and the porous body in order to prevent the reaction gas supplied to the porous body from flowing out into the cavity; and
stacking the separator and the power generating unit alternately, with the porous body being interposed between the separator and the power generating unit.
